(19) United States
(12) Patent Application Publication
(10) Pub. No.: US 2024/0381852 A1
(43) Pub. Date: Nov. 21, 2024

(54) Squirrel-Proof Bird Feeder Enclosure Structure

(71) Applicant: Munem Alidina, Short Hills, NJ (US)

(72) Inventor: Munem Alidina, Short Hills, NJ (US)

(21) Appl. No.: 18/751,488

(22) Filed: Jun. 24, 2024

(51) Int. Cl. A01K 39/01

(52) U.S. Cl. CPC A01K 39/0113

(57) ABSTRACT

This invention relates to a method and structure designed to prevent squirrels and other animals from accessing bird feeders. The solution employs aluminum or other weather resistant metal rings, each with an inner diameter of 1.5 inches (with 3 mm tolerance), to create barriers that are mounted on a wooden, polycarbonate or similar weather resistant platform. These rings are connected to each other and to the glass or other clear weather resistant front and back panels using silicone adhesive or a small nut and bolt. The structure ensures that no entry point exceeds 1.5 inches, effectively deterring non-bird animals from accessing the enclosed space.

### BACKGROUND OF THE INVENTION

Bird enthusiasts often struggle with the problem of squirrels and other animals accessing bird feeders. These intruders not only consume bird feed, but can also damage the feeders, leading to frequent replacements and maintenance issues. Various methods have been tried to keep these animals at bay, but many prove ineffective.

This invention addresses the need for a reliable and durable solution to prevent squirrels and other animals from accessing bird feeders while allowing birds to feed undisturbed. By using a structure composed of interconnected metal rings, this invention creates a barrier that is small enough to block larger animals but large enough to allow birds to pass through.

### SUMMARY OF THE INVENTION

The invention provides a method and structure for preventing non-bird animals from accessing bird feeders. The primary components are metal rings with an inner diameter of 1.5 inches (with 3 mm tolerance) and 0.5 inch length (with ⅛ inch tolerance). These rings are arranged to form two walls, creating a barrier structure. The rings are connected using silicone adhesive or small nuts and bolts.

The two walls of rings are mounted on a wooden, polycarbonate or similar weather resistant platform and secured with glass or similar weather and squirrel resistant front and back panels. A roof is then placed on top, and if necessary, additional rings are used to fill any gaps between the walls and the roof to ensure no entry point exceeds 1.5 inches. This arrangement allows birds to access the feeder while preventing larger animals like squirrels from entering.

### BRIEF DESCRIPTION OF THE DRAWINGS

The following artifacts provide an illustrative visual representation, but several configurations are possible with the described structure.

FIG. 1: Exploded view of the entire bird feeder protection structure, showing the arrangement of rings, the wooden or polycarbonate platform, glass panels, and the roof.

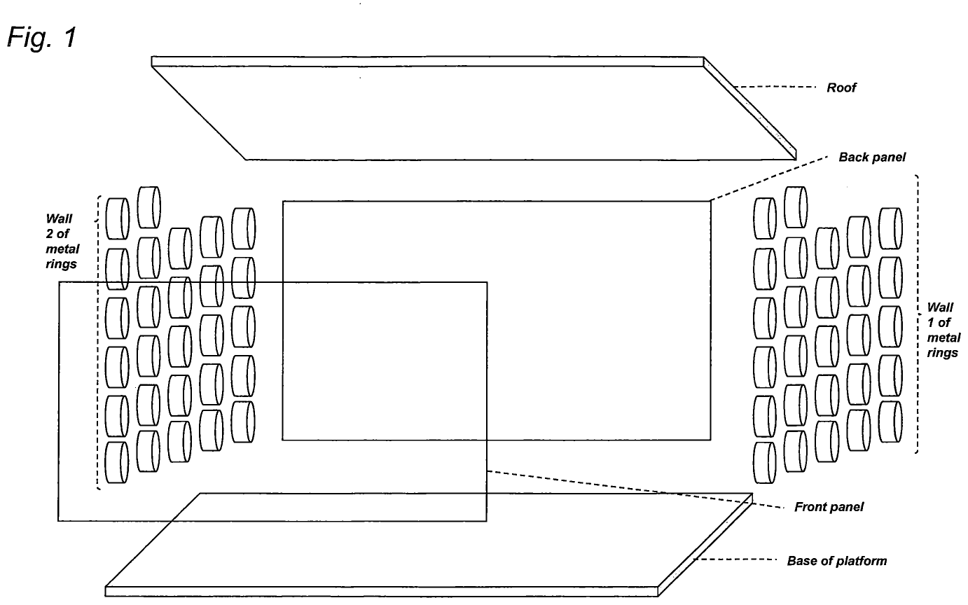

FIG. 2: Side view of the assembled structure, highlighting the placement and connection of the rings.

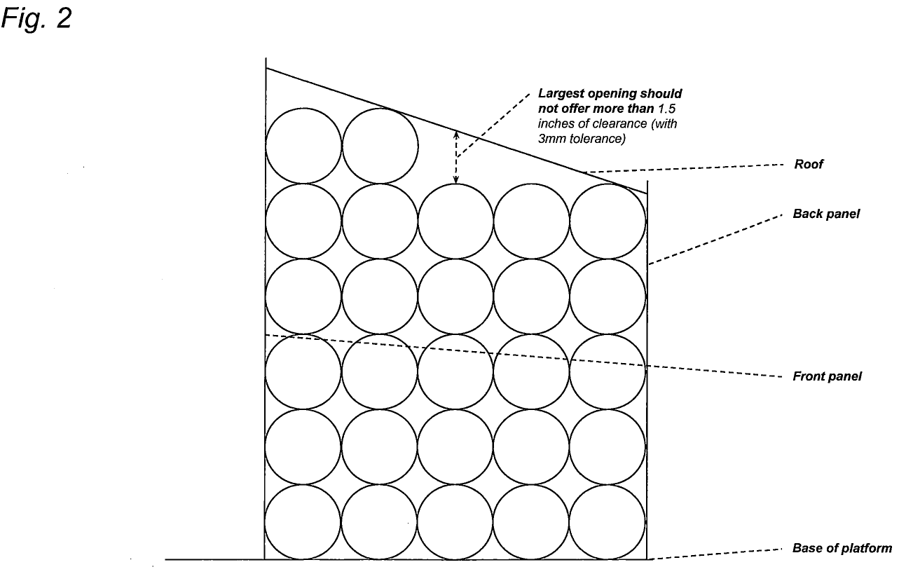

FIG. 4: Detailed view of the connection method between the rings using silicone adhesive and nuts and bolts.

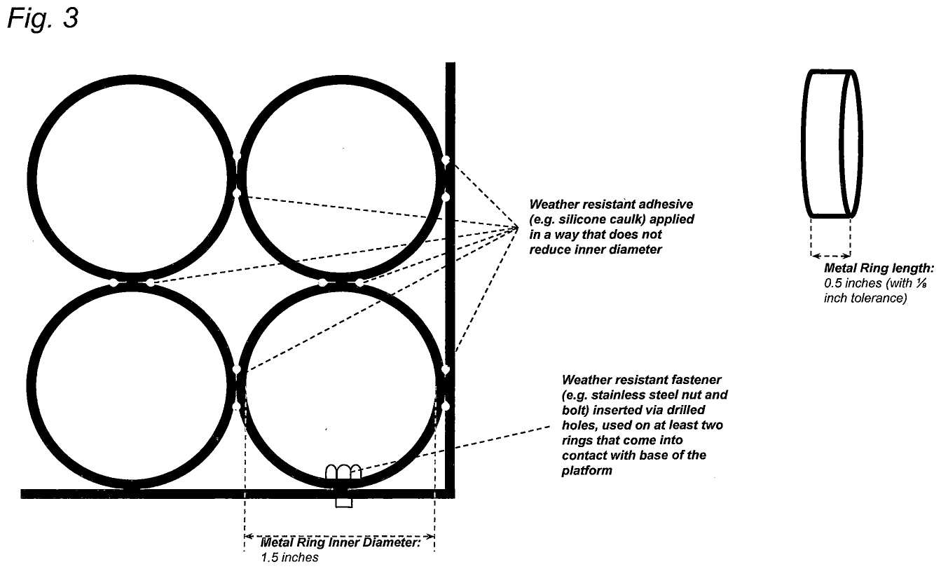

### DETAILED DESCRIPTION OF THE INVENTION

The structural components and assembly comprise of

### Rings:

The primary barrier is constructed using aluminum or other metal rings that are weather resistant (e.g. steel).

Each ring has an inner diameter of 1.5 inches and an outer diameter of approximately 1.625 inches. The length of each ring is 0.5 inches.

There is some flexibility in the outer diameter, allowing slight variations to accommodate different design requirements.

The rings can be joined together using small nuts and bolts can be used, requiring holes to be drilled through the rings. Weather resistant silicone adhesive can also be used as an alternative.

### Wooden or Polycarbonate Platform:

The base of the structure is a wooden or polycarbonate platform, which supports the walls of rings and provides a stable foundation. An alternate weather and squirrel resistant material can be used for the platform.

The platform's dimensions can vary based on the size of the bird feeder it is intended to protect.

### Glass Panels:

The front and back of the structure are enclosed using glass panels.

These panels are attached to the ring walls using silicone adhesive or small nuts and bolts, ensuring a secure and weather-resistant connection.

The transparency of the glass panels allows for visibility while maintaining the integrity of the barrier.

### Roof:

A roof is placed on top of the structure to provide cover and additional protection from above. The roof can be made of wood, polycarbonate or an alternate weather and squirrel resistant material.

The roof can be adjusted to fit snugly against the top of the ring walls.

If there is any clearance between the walls and the roof, additional rings can be added to close the gap, ensuring no openings larger than 1.5 inches.

The components can be assembled as described below:

### Ring Wall Construction:

Begin by arranging the metal rings side by side to form the two primary walls.

Connect the rings using either silicone caulk adhesive or similar strength weather and squirrel resistant material that does not reduce the inner diameter of the ring

The number of rings, configuration and the overall size of the walls can vary depending on the specific design and size of the bird feeder or birdhouse.

### Mounting on the Platform:

Attach the constructed walls of rings to the wooden or polycarbonate platform.

Use silicone caulk adhesive or nuts and bolts to ensure a firm attachment to the platform.

### Installing Glass Panels:

Secure the glass front and back panels to the walls of rings.

Ensure that the panels are properly aligned and firmly attached using the chosen connection method.

### Adding the Roof:

Place the roof on top of the structure.

Adjust the fit as necessary to ensure there are no gaps larger than 1.5 inches. If needed, add additional rings to close any gaps between the walls and the roof.

### FUNCTION AND OPERATION

The completed structure effectively prevents squirrels and other large animals from accessing the bird feeder. The rings create a barrier that is too small for these animals to pass through, yet allows birds to enter and exit freely. The robust connections and materials used ensure the structure is durable and capable of withstanding outdoor conditions.

1. A method for preventing non-bird access to bird feeders, comprising a) Arranging metal rings that each have an inner diameter of 1.5 inches and 0.5 inch length to form a barrier, b) Connecting the rings using similar weather resistant material such as silicone caulk, c) Mounting the barrier on a wooden or polycarbonate platform, d) Securing the barrier with glass panels attached to the front and back, e) Placing a roof on top, adjusting to ensure no accessible entry point exceeds 1.5 inches in clearance.

2. The structure for preventing non-bird access to bird feeders as described in claim 1, wherein: a) The metal rings have an inner diameter of 1.5 inches with 3 mm size tolerance, b) Additional rings are used to close gaps between the ring walls and the roof.

3. The structure for preventing non-bird access to bird feeders as described in claim 1, wherein a) The rings are connected to each other and to the glass panels using silicone adhesive or small nuts and bolts or similar apparatus, b) The glass panels provide visibility while maintaining a secure enclosure.
